(19) United States
(12) Patent Application Publication
(10) Pub. No.: US 2002/0174835 A1
(43) Pub. Date: Nov. 28, 2002

(54) Portable pet food or water bowl

(75) Inventors: Hyung Joo Kwon, Seoul (KR); Jee Hyun Song, Riverdale, NY (US)

Correspondence Address: MAYER, FORTKORT & WILLIAMS, PC, 251 NORTH AVENUE WEST, 2ND FLOOR, WESTFIELD, NJ, 07090, US

(73) Assignee: BRDC Group Inc,, New York, NY (US)

(21) Appl. No.: 10/147,281

(22) Filed: May 16, 2002

Related U.S. Application Data
(60) Provisional application No. 60/292,678, filed on May 22, 2001.

(51) Int. Cl. A01K 1/10; A01K 5/00; A01K 39/00

(52) U.S. Cl. 119/61

(57) ABSTRACT

A collapsible pet food/water bowl can be folded to about half its size or more. A carrying case accommodates the bowl when collapsed. The collapse of the bowl is enabled by removable vertical supports and circular skeletal rings at the ends of the bowl. These enable the bowl to be vertically collapsed, then twisted into a figure eight, the ellipses of which can be folded on top of each other. The collapsed, twisted and folded bowl can then be inserted into a carrying case that holds the bowl in the collapsed position.

### STATEMENT OF RELATED APPLICATION

This application claims the benefit of priority to U.S. Provisional Patent Application No. 60/292,678, entitled “Portable Pet Food or Water Bowl”, filed May 22, 2001.

### BACKGROUND OF THE INVENTION

The present invention relates generally to pet food bowls and more particularly to pet food bowls that can be transported easily by the pet owners.

When traveling with their pet, pet owners must carry many paraphernalia related to their pet. By themselves each of these items is not significant in terms of bulk and weight, but as a group these items become unwieldy, especially given that the pet owners are probably also carrying their own baggage. One item that adds to the bulk is the food bowl. Particularly, where the pet and pet owner are traveling to a place that does not have bowls available, carrying a pet bowl itself can be inconvenient.

The present invention is therefore directed to the problem of developing a portable pet food bowl that can be easily carried.

### SUMMARY OF THE INVENTION

The present invention solves this and other problems by providing a collapsible pet food bowl and carrying case.

### BRIEF DESCRIPTION OF THE DRAWINGS

FIG. 1 depicts a top view of an exemplary embodiment of a carrying case according to one aspect of the present invention.

FIG. 2 depicts a back view of the exemplary embodiment of FIG. 1.

FIG. 3 depicts an end view of the exemplary embodiment of FIG. 1.

FIG. 4 depicts a top view of the exemplary embodiment of FIG. 1 when opened.

FIG. 5 depicts an end view of a support tab used in an exemplary embodiment according to another aspect of the present invention.

FIG. 6 depicts a cross sectional view of an exemplary embodiment according to one aspect of the present invention.

FIGS. 7-9 depict an exemplary embodiment according to one aspect of the present invention in various stages of folding.

FIG. 10 depicts a top view of an exemplary embodiment according to one aspect of the present invention.

FIG. 11 depicts a detail view of a support used in the above embodiment and a sleeve to hold the support.

### DETAILED DESCRIPTION

It is worthy to note that any reference herein to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

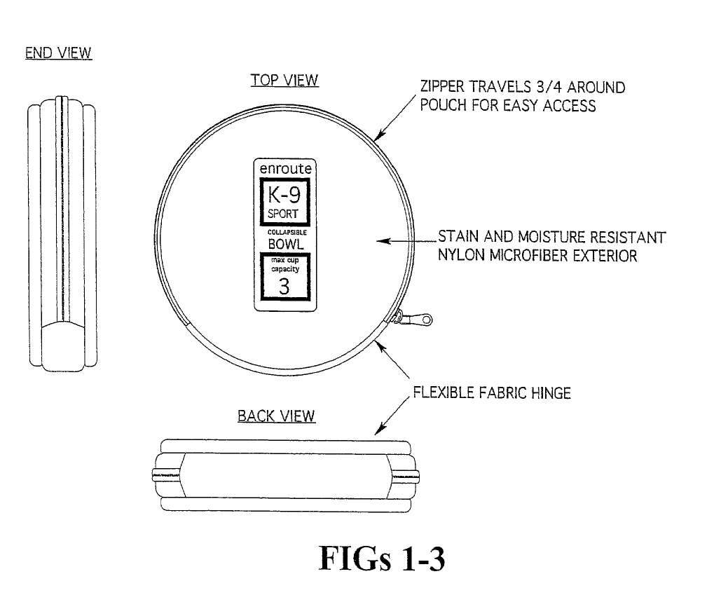

Referring to FIG. 1, shown therein is a top view of an exemplary embodiment 10 of the present invention. The embodiment 10 includes a carrying case 11, and a collapsible bowl 12. The bowl is designed to twist and collapse into the carrying case, which when filled with the collapsible bowl is approximately five inches in diameter and about one inch in width. A zipper 12 is disposed on the circumference of the carrying case 11 and travels about ¾ of the circumference to allow for easy insertion of the collapsible bowl into the carrying case 11. The hinge 13 of the case is made of flexible fabric to allow for a wide opening.

FIG. 2 depicts a back view of the case, which shows the hinge 13. FIG. 3 depicts an end view of the case 11, in which can be seen the hinge 13 and a portion of the zipper 12.

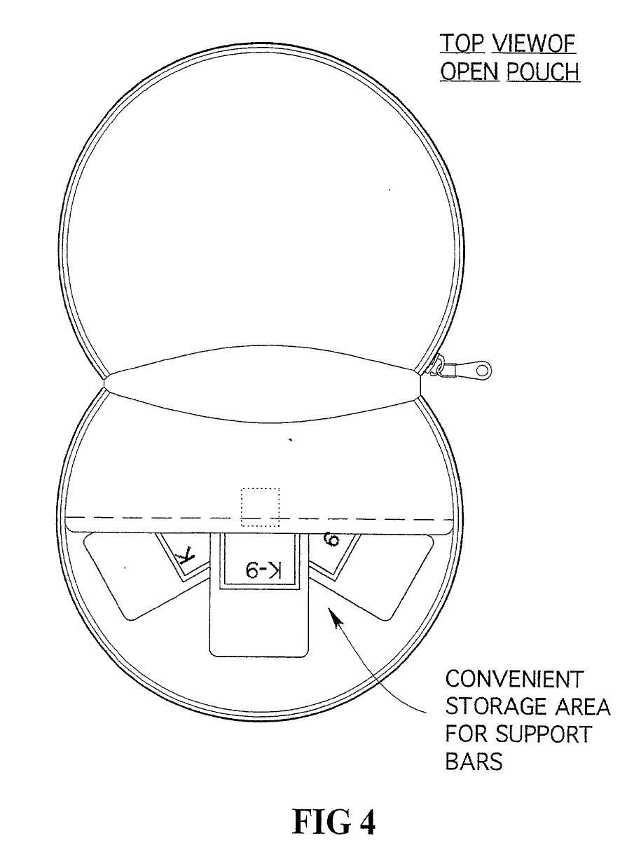

FIG. 4 depicts the case 11 when fully opened. A pouch 14 in the interior of the case 11 stores support bars 15, which will be discussed later.

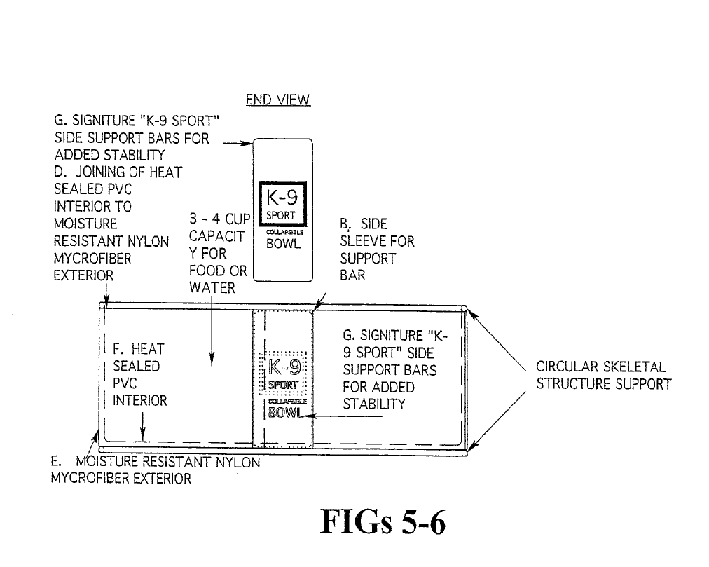

FIG. 5 depicts a support bar 15, which is rectangular in cross section having a length of about three inches and a width of about one inch. The thickness of the support bar 15 is about 1/10 cm.

FIG. 6 depicts an exemplary embodiment of the collapsible bowl 20. The bowl 20 includes sleeves 21-23 into which the support bars 15 can be inserted to provide stability to the bowl 20 when in use. The sleeves are disposed equidistant around the circumference of the bowl. The bowl 20 has a 3-4 cup capacity. When completely opened, the bowl is about eight inches in diameter. The bowl includes two circular skeletal supports 24, 25 that encircle the top and bottom of the bowl. When the support bars are inserted, the combination of the circular skeletal supports and the support bars is sufficient to hold food or liquid in the bowl 20. The bowl 20 includes a heat sealed PVC material on the interior and moisture resistant nylon microfiber on the exterior, which is joined at the edges.

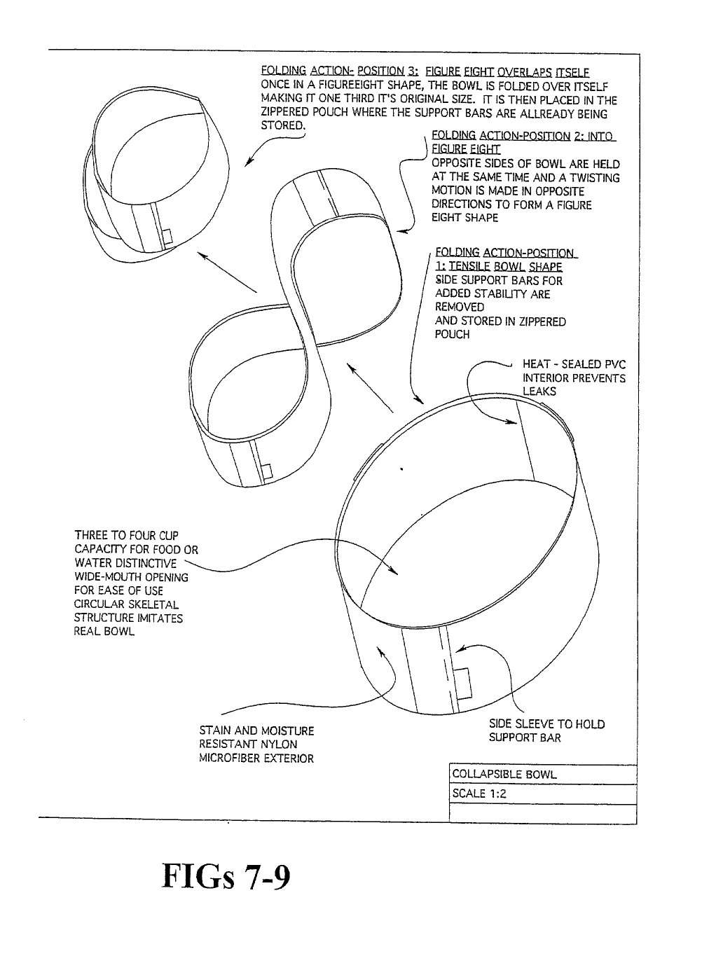

FIGS. 7-9 depict the collapsible bowl 20 in various stages of folding. FIG. 7 depicts the bowl 20 in position 1. The tensile bowl shape includes three side support bars 21-23 for added stability. These bars 21-23 are first removed from sleeves 21-23 when collapsing the bowl 20 and stored in the pouch in the carrying case. A material comprised of heat-sealed PVC for the interior prevents leaks. The bowl 20 has a three to four cup capacity for food or water or other liquid. The bowl 20 includes a wide-mouth opening for ease of use. The circular skeletal structure 24, 25 imitates a non-collapsible bowl. The exterior of the bowl is made of a stain and moisture resistant nylon microfiber material.

Turning to FIG. 8, the bowl 20 is shown in a second position when in the process of being collapsed. The bowl is formed into a figure eight by grasping opposite ends and twisting the opposite ends in opposite directions. This can easily be accomplished by placing one's thumbs on opposite end surfaces of the bowl and then holding on to the bowl 20 and rotating one's hands so that one's thumbs are now in the same plane.

FIG. 9 shows the third position of the bowl when being collapsed. The ellipses of the figure eight are then folded on top of each other. This way the bowl can be folded into about one third to one half its diameter. Thus, a bowl 20 of about 8 inches in diameter is folded to about four inches in diameter. Once folded, the bowl is placed in the carrying case.

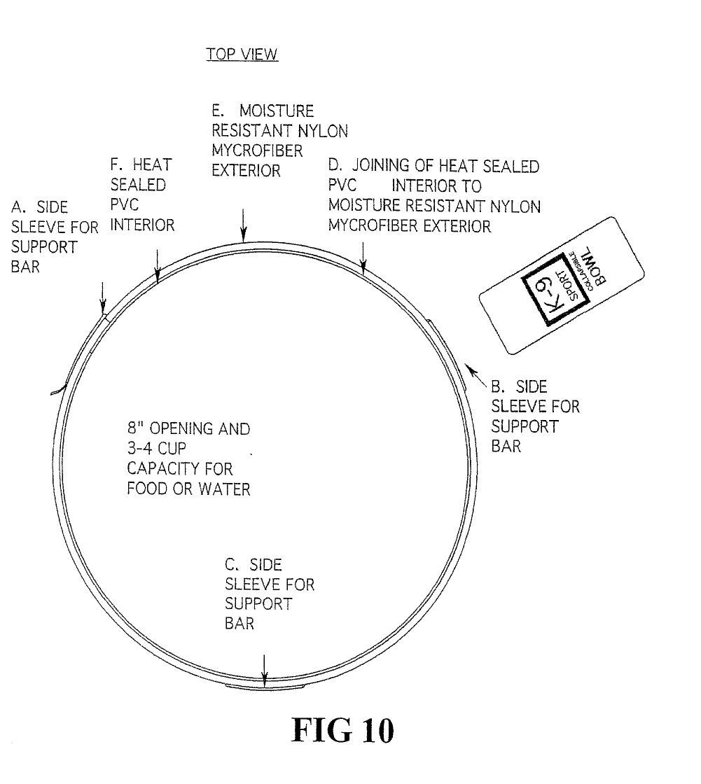

Turning to FIG. 10, shown therein is a top view of the exemplary embodiment 20. Sleeves 21-23 for support bars 15 are disposed equidistant around the bowl. The heat sealed PVC material on the interior is joined to the moisture resistant nylon microfiber material on the exterior at interface 26.

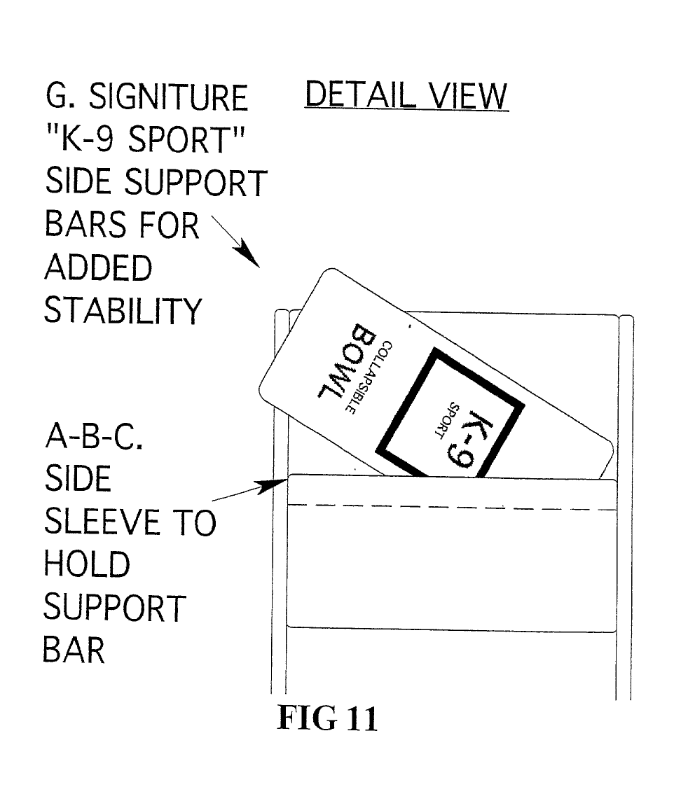

FIG. 11 depicts a detail view of a support used in the above embodiment and a sleeve to hold the support. The support bars 15 can be inserted into the sleeves 21-23 as the dimensions of the sleeves are slightly larger than the dimensions of the support bars. Once inserted, the support bars provide vertical stability to the bowl.

Although various embodiments are specifically illustrated and described herein, it will be appreciated that modifications and variations of the invention are covered by the above teachings and within the purview of the appended claims without departing from the spirit and intended scope of the invention.

What is claimed is:

1. An apparatus for holding pet food or liquid comprising:
a cylindrical shaped bowl having two circular skeletal rings at each end of the cylinder, wherein the rings are twistable into a figure eight; and
a plurality of sleeves disposed in vertical surfaces of the cylinder.

2. The apparatus according to claim 1, further comprising a plurality of removable vertical supports, wherein the plurality of sleeves accommodate the plurality of vertical supports.

3. The apparatus according to claim 2, further comprising a water-retaining material in which the two rings and the plurality of sleeves are disposed.

4. The apparatus according to claim 3, wherein the water-retaining material comprises a heat-sealed PVC material on an interior of the bowl.

5. The apparatus according to claim 4, wherein the water-retaining material comprises a moisture resistant nylon microfiber material on the exterior of the bowl.

6. The apparatus according to claim 1, further comprising a pouch, into which the bowl fits in a collapsed configuration.

7. The apparatus according to claim 6, wherein the pouch includes a zipper.

8. The apparatus according to claim 6, wherein the pouch includes a pocket for storing the plurality of removable vertical supports.

9. A method for collapsing a pet food or water container comprising:
removing a plurality of vertical support bars;
collapsing the container vertically;
twisting the collapsed container into a figure eight; and
overlaying ellipses of the figure eight on top of each other.

10. The method according to claim 8, further comprising inserting the overlaid structure into a carrying case.

11. The method according to claim 10, further comprising inserting the plurality of vertical support bars into a pocket in the carrying case.

12. A collapsible apparatus for holding pet food or liquid comprising:
a cylindrical shaped bowl having two circular skeletal rings at each end of the cylinder, said cylinder including a water-retaining material forming a surface area of the cylinder, into which material the circular skeletal rings are disposed at two ends of the cylinder; and
a plurality of removable vertical supports.

13. The apparatus according to claim 12, further comprising a plurality of sleeves disposed in the material forming vertical surfaces of the cylinder for accommodating the plurality of removable vertical supports.

14. The apparatus according to claim 12, wherein the water-retaining material includes seams into which the rings are sewn.

15. The apparatus according to claim 12, further comprising a pouch, into which the bowl fits in a collapsed configuration.

16. The apparatus according to claim 15, wherein the pouch is made of a same water-retaining material as the bowl.

17. The apparatus according to claim 15, wherein the pouch includes a zipper for opening and closing the pouch.

18. The apparatus according to claim 12, wherein the water-retaining material comprises a heat-sealed PVC material on an interior of the bowl.

19. The apparatus according to claim 18, wherein the water-retaining material comprises a moisture resistant nylon microfiber material on the exterior of the bowl.

20. The apparatus according to claim 16, wherein the pouch includes a pocket for storing the plurality of removable vertical supports.
